(19) United States
(12) Patent Application Publication
(10) Pub. No.: US 2011/0124389 A1
(43) Pub. Date: May 26, 2011

(54) MILEAGE GAME SYSTEM FOR RUNNING VEHICLE AND METHOD THEREOF

(75) Inventor: Dae Kun Lee, Seoul (KR)

(73) Assignees: HYUNDAI MOTOR COMPANY, Seoul (KR); KIA MOTORS CORPORATION, Seoul (KR)

(21) Appl. No.: 12/754,155

(22) Filed: Apr. 5, 2010

(30) Foreign Application Priority Data
Nov. 25, 2009 (KR) 10-2009-0114561

(51) Int. Cl. A63F 9/24

(52) U.S. Cl. 463/9

(57) ABSTRACT

The present invention features, in part, a mileage game system for a running vehicle and a method thereof are disclosed. In preferred embodiments, the mileage game system includes an operation unit enabling a driver to select a mileage game, and generating mileage game data that has an influence on a gas efficiency; a data collecting unit collecting the mileage game data by using a CAN communication; a data processing unit computing a mileage game score from the mileage game data according to a mileage game program previously installed, and calculating the total score of the mileage game scores reflected by the generated mileage game score; and a display screen displaying the total score of the calculated mileage game scores.

### CROSS-REFERENCE TO RELATED APPLICATION

This application claims under 35 U.S.C. §119(a) the benefit of Korean Patent Application No. 10-2009-0114561, filed on Nov. 25, 2009 in the Korean Intellectual Property Office, the disclosure of which is incorporated herein in its entirety by reference.

### BACKGROUND

1. Field of the Invention

The present invention relates, generally, to gas mileage of a vehicle, and more particularly, to a mileage game system for a running vehicle and a method thereof, which comprises collecting items having an influence on the gas mileage of the running vehicle.

2. Background Art

In general, due to the development of the automobile industry, the increased demand for various conveniences of consumers and the enforcement of safety, as various control units have been studied and developed, the wiring for mutually transmitting and receiving information between the control units has increased. Accordingly, this causes the weight of the vehicle to increase, and gas mileage is thus deteriorated. Further, it is considerably difficult to design and install the wiring. Therefore, reduction of complexity associated with the wiring operation is needed in the manufacture and design of vehicles.

The control units mounted in the vehicle are connected to each other via a CAN communication network, which considerably reduces the amount of wiring to reduce the cost of the vehicle and enhance the efficiency of design and installation of the wiring, and which also lowers the weight of the vehicle to reduce the gas mileage. Further, more complex and various functions are suitably provided by interaction of the respective control units.

Further, with increased attention for improved gas mileage vehicles, various functions are employed in vehicles in an effort to lead a driver to drive at high fuel efficiency. Accordingly, systems directed at providing a consumer with fuel-efficient driving habits have been developed.

For example, according to known systems, current gas mileage is displaced by a lamp color of red or blue, or instant or average gas mileage is displayed, however, based on these displays, the driver is hardly able to perceive the driving of high fuel efficiency.

Accordingly, there remains a need in the art for systems that can lead a driver to drive at high fuel efficiency.

The above information disclosed in this the Background section is only for enhancement of understanding of the background of the invention and therefore it may contain information that does not form the prior art that is already known in this country to a person of ordinary skill in the art.

### SUMMARY OF THE INVENTION

In one aspect, the present invention is directed to providing a mileage game system for a running vehicle and a method thereof, which can realize a game by collecting items having an influence on the gas mileage of the running vehicle via a CAN communication applied to the vehicle to lead a driver to drive at a suitably high fuel efficiency.

The present invention also provides a mileage game system for a running vehicle using a CAN communication and a method thereof which can realize a game in a suitably cheap and effective way by using components provided in the vehicle.

In preferred embodiments, the present invention preferably provides a mileage game system for a running vehicle, which preferably includes an operation unit enabling a driver to suitably select a mileage game, and generating mileage game data having an influence on a gas efficiency; a data collecting unit suitably collecting the mileage game data by using a CAN communication; a data processing unit suitably computing a mileage game score from the mileage game data according to a mileage game program previously installed, and calculating the total score of the mileage game scores reflected by the generated mileage game score; and a display screen suitably displaying the total score of the calculated mileage game scores.

According to certain preferred embodiments of the present invention, the mileage game data may include an instant gas mileage, a vehicle speed, RPM, APS (accelerator pedal value signal), and an air conditioner adjusting level.

Preferably, the mileage game score is calculated by the mileage game data according to the following equation:

mileage game score=[10+{(instant mileage/authorized gas mileage)*5}+[4-(RPM/1000)]+{(50 -acceleration opening rate (%))/10}-{|speed-70|/20}-air-conditioner adjusting level]

In preferred exemplary embodiments, the mileage game data is suitably generated by at least one of mileage game data generating units including an engine, an ECU and an air conditioner.

Preferably, the mileage game data generated by the engine and the ECU is suitably transmitted via a high-speed chassis CAN, and the mileage game data generated by the air conditioner is suitably transmitted through a low-speed body CAN or a multimedia CAN.

Preferably, the mileage game data generating unit suitably transmits a corresponding mileage game data to a CAN gateway in the CAN communication, and the CAN gateway suitably transmits the corresponding mileage game data to the data collecting unit.

In another preferred aspect, the present invention preferably provides a mileage game method for a running vehicle, which includes the steps of A) suitably collecting mileage game data by a data correcting unit; B) suitably computing a mileage game score from the collected mileage game data according to a mileage game program previously installed; C) suitably counting a mileage game proceeding time, and judging whether the time is less than a predetermined lower limit; D) if the mileage game proceeding time is less than the predetermined lower limit, suitably judging whether the mileage game score is less than 0; E) if the mileage game time is more than the predetermined lower limit or the mileage game score is larger than 0, adding the calculated mileage game score to the previous total score so that the total score is set to the current total of the mileage game score; F) suitably judging whether the current total score is less than 0; G) if the total score is not less than 0, suitably judging whether the mileage game proceeding time has gone by a predetermined upper limit time, by counting the mileage game proceeding time; and H) if the current total score is less than 0 or if the mileage game time has gone by the predetermined upper limit time, completing the game.

preferably, if the mileage game score calculated at the step D is less than 0, the mileage game data is again collected via a CAN communication.

According to preferred embodiments, the predetermined lower limit time is set to 1 minute, and the predetermined upper limit time is set to 10 minutes.

Preferably, the mileage game data of the step A includes an instant gas mileage, a vehicle speed, RPM, APS (accelerator pedal value signal), and an air conditioner adjusting level.

In certain exemplary embodiments, the mileage game score of the step B is calculated by the mileage game data according to the following equation:

mileage game score=[10+{(instant mileage/authorized gas mileage)*5}+[4-(RPM/1000)]+{(50 -acceleration opening rate (%))/10}-{|speed-70|/20}-air-conditioner adjusting level]

According to the present invention as described herein, the mileage game system can be suitably realized by collecting items having an influence on the gas mileage of the running vehicle via a CAN communication applied to the vehicle, thereby leading a driver to drive at a suitably high fuel efficiency.

Further, it is a preferred embodiment of the present invention that the mileage game system can be realized in a cheap and effective way by using components provided in the vehicle.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum).

As referred to herein, a hybrid vehicle is a vehicle that has two or more sources of power, for example both gasoline-powered and electric-powered.

The above features and advantages of the present invention will be apparent from or are set forth in more detail in the accompanying drawings, which are incorporated in and form a part of this specification, and the following Detailed Description, which together serve to explain by way of example the principles of the present invention.

### BRIEF DESCRIPTION OF THE DRAWINGS

The above and other features of the present invention will now be described in detail with reference to certain exemplary embodiments thereof illustrated by the accompanying drawings which are given hereinafter by way of illustration only, and thus are not limitative of the present invention, and wherein:

FIG. 1 is a diagram illustrating an exemplary mileage game system of a running vehicle using a CAN communication according to an embodiment of the present invention;

FIG. 2 is a diagram illustrating an exemplary mileage game system of a running vehicle according to an embodiment of the present invention;

FIG. 3 is a flowchart illustrating operation of an exemplary mileage game system of a running vehicle according to an embodiment of the present invention; and

FIG. 4 is a flowchart illustrating operation of an exemplary mileage game system of a running vehicle according to an embodiment of the present invention.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

### DETAILED DESCRIPTION OF THE PREFERRED EMBODIMENTS

As described herein, the present invention includes a mileage game system for a vehicle, comprising an operation unit, a data collecting unit, a data processing unit, and a display screen.

In one embodiment, the operation unit enables a driver to select a mileage game, and generates mileage game data having an influence on a gas efficiency.

In another embodiment, the data collecting unit collects the mileage game data by using a CAN communication.

In another further embodiment, the data processing unit computes a mileage game score from the mileage game data according to a mileage game program previously installed, and calculates the total score of the mileage game scores reflected by the generated mileage game score.

In still another embodiment, the display screen displays the total score of the calculated mileage game scores.

In another aspect, the present invention features a mileage game method for a running vehicle, comprising the steps of A) collecting mileage game data by a data correcting unit, B) computing a mileage game score from the collected mileage game data according to a mileage game program previously installed, C) counting a mileage game proceeding time, and judging whether the time is less than a predetermined lower limit, D) if the mileage game proceeding time is less than the predetermined lower limit, judging whether the mileage game score is less than 0, E) if the mileage game time is more than the predetermined lower limit or the mileage game score is larger than 0, adding the calculated mileage game score to the previous total score so that the total score is set to the current total of the mileage game score, F) judging whether the current total score is less than 0, G) if the total score is not less than 0, judging whether the mileage game proceeding time has gone by a predetermined upper limit time, by counting the mileage game proceeding time, and H) if the current total score is less than 0 or if the mileage game time has gone by the predetermined upper limit time, completing the game.

Hereinafter, preferred embodiments of the present invention will be described in detail with reference to the accompanying drawings. The aspects and features of the present invention and methods for achieving the aspects and features will be apparent by referring to the embodiments to be described in detail with reference to the accompanying drawings. However, the present invention is not limited to the embodiments disclosed hereinafter, but can be implemented in diverse forms. The matters defined in the description, such as the detailed construction and elements, are nothing but specific details provided to assist those of ordinary skill in the art in a comprehensive understanding of the invention, and the present invention is only defined within the scope of the appended claims. In the entire description of the present invention, the same drawing reference numerals are used for the same elements across various figures.

In a preferred embodiment of the present invention, there is provided a mileage game system of a running vehicle and a method thereof which can realize a game by collecting items having an influence on the gas mileage of the running vehicle via a CAN communication applied to the vehicle to lead a driver to drive at suitably high fuel efficiency.

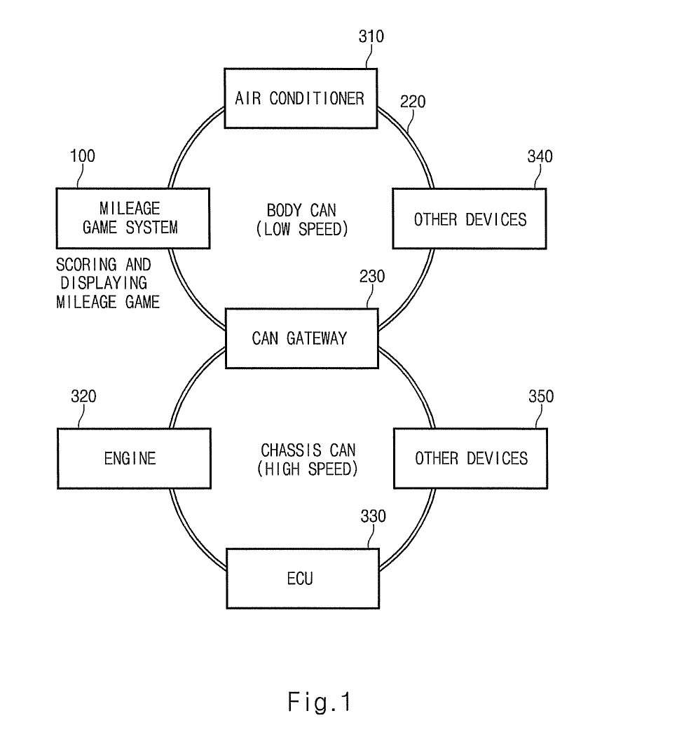

FIG. 1 is an exemplary diagram illustrating the mileage game system for the running vehicle using the CAN communication according to an embodiment of the present invention.

According to certain preferred embodiments, and referring to FIG. 1, the mileage game system for the running vehicle according to an exemplary embodiment of the present invention suitably collects mileage game data via a controller area network (CAN) communication including a high-speed CAN 210, a low-speed CAN 220 and a CAN gateway 230. In certain preferred embodiments, the high-speed CAN 210 is a chassis CAN, and the low-speed CAN 220 is a body CAN or multimedia CAN. In further preferred embodiments, the CAN gateway 230 is a device for suitably transferring data between the high-speed CAN 210 and the low-speed CAN 220 in the CAN communication.

According to certain embodiments of the present invention, the mileage game data can be created by at least one of mileage game data generating units preferably including an engine 320, an ECU 330 and an air conditioner 310. Preferably, the mileage game data generated by the engine 320 and the ECU 330 or other devices 350 is suitably transmitted via the high-speed chassis CAN 210, and the mileage game data generated by the air conditioner 310 or other devices 340 is suitably transmitted through the low-speed body CAN 220 or the multimedia CAN.

Accordingly, the mileage game system 100 of running vehicle according to a preferred embodiment of the present invention can score and display a mileage game.

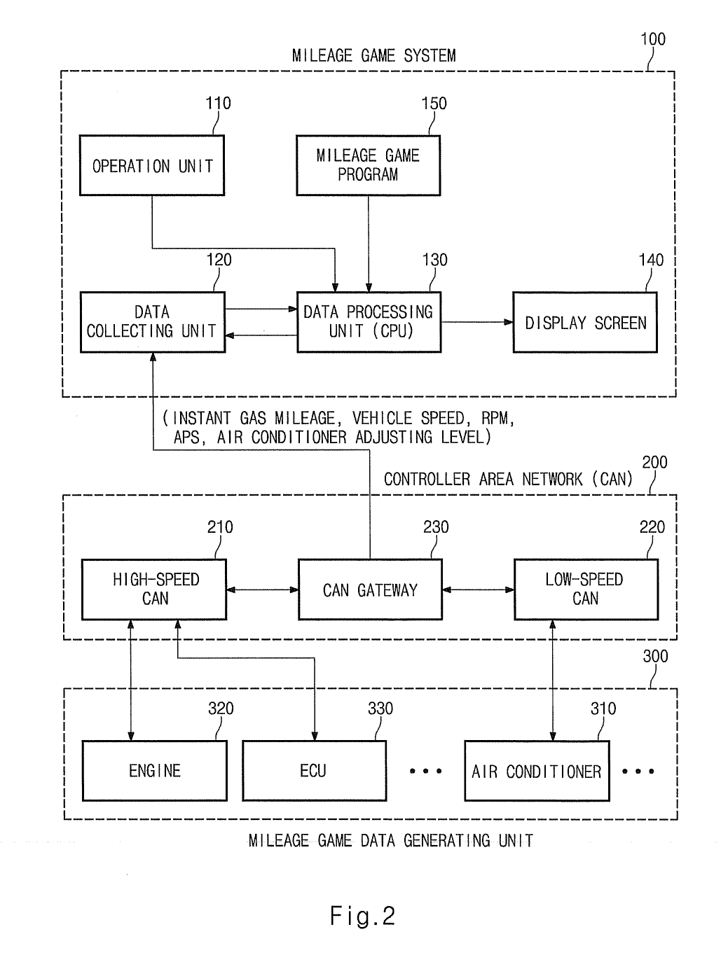

FIG. 2 is a diagram illustrating the mileage game system for the running vehicle according to a further preferred embodiment of the present invention.

Referring to FIG. 2, in certain preferred embodiments, the mileage game system 100 of the running vehicle preferably includes an operation unit 110, a data correcting unit 120, a data processing unit 130, a display screen 140 and a mileage game program 150. In further preferred embodiments, the CAN 200 includes the high-speed CAN 210, the low-speed CAN 220, and the CAN gateway 230.

In one exemplary embodiment, the mileage game data generating unit 300 suitably generates the mileage game data having an influence on the gas efficiency, and may preferably include the engine 320, the ECU 330 and the air conditioner 310, which is not limited thereto.

Preferably, the operation unit 110 of the mileage game system 110 suitably enables a driver to select a mileage game, and generates the mileage game data that has an influence on a gas efficiency. Accordingly, if the driver selects the operation unit 110, the mileage game data generating unit 300 generates the mileage game data.

In further preferred embodiments, the data collecting unit 120 collects the mileage game data by using the CAN communication.

According to certain exemplary embodiments, the data processing unit 130 may preferably be a CPU, and suitably computes a mileage game score from the mileage game data according to the mileage game program 150 previously installed, and suitably calculates the total score of the mileage game scores reflected by the generated mileage game score.

Preferably, in this instance, the data for realizing the mileage score includes an instant gas mileage, a vehicle speed, RPM, APS (accelerator pedal value signal), and an air conditioner adjusting level, and may preferably be given as follows, in which the mileage game score may be revised after discussion between subsidiary organizations:

mileage game score=[10+{(instant mileage/authorized gas mileage)*5}+[4-(RPM/1000)]+{(50 -acceleration opening rate (%))/10}-{|speed-70|/20}-air-conditioner adjusting level]

Preferably, the display screen 140 displays the total score for the calculated mileage game scores.

According to certain embodiments of the present invention, the high-speed CAN 210 of the CAN 200 may be a chassis CAN, and the low-speed CAN 220 may be a body CAN or multimedia CAN. In this instance, the CAN gateway 230 is a device for transferring the data between the CANs. Preferably, in the case in which the mileage game system 110 is suitably connected to all CANs, the CAN gateway 230 may be not necessary.

In certain preferred embodiments, the mileage game data generating unit 300 suitably transmits the mileage game data to the corresponding CAN gateway 230 in the CAN, and the CAN gateway 230 suitably transmits the corresponding mileage game data to the data collecting unit 120.

According to further preferred embodiments of the present invention, in the mileage game system 100 of the running vehicle, the game starts in accordance with a suitable start signal of a user, the units (e.g., the engine, the ECU, or the air conditioner) generating the mileage game data suitably transmit the corresponding data to the CAN gateway 230 in the one's CAN. After that, the CAN gateway 230 transmits the corresponding information to the mileage game system. Accordingly, the mileage game system 100 suitably generates a specific score based on the received data, and accumulates and displays the generated scores on the screen. Preferably, if an appointed time is over or the score becomes zero, the mileage game is completed.

According to a further preferred embodiment of the present invention, the mileage game system can suitably rouse a driver's interest and promote participation, and can be suitably implemented inexpensively by preferably using the components existing in the vehicle. The CAN is a technique already applied to the vehicle, and the mileage game system can be suitably implemented by collecting existing data associated with gas mileage, without increasing the cost significantly.

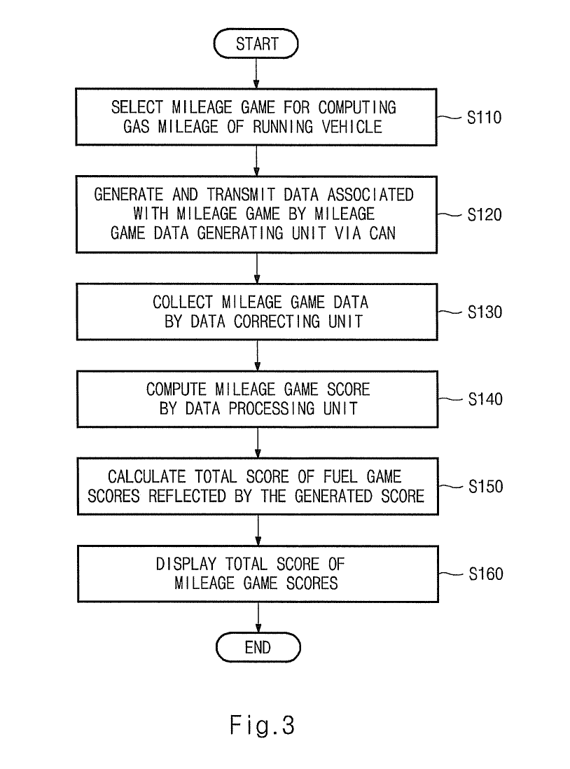

FIG. 3 is a flowchart illustrating operation of the mileage game system of the running vehicle according to a further preferred embodiment of the present invention.

Referring to FIG. 3 for example, in a mileage game method of the running vehicle according to an exemplary embodiment of the present invention, first, if the driver selects a mileage game computing a gas mileage of the running vehicle which is suitably installed in the vehicle (S110), the mileage game data generating unit 300 suitably generates the mileage game data, and suitably transmits it to the data processing unit 130 via the CAN (S120). Preferably, the mileage game data includes an instant gas mileage, a vehicle speed, RPM, APS (accelerator pedal value signal), and an air conditioner adjusting level. In further preferred embodiments, the mileage game data may be suitably generated by the mileage game data generating unit 300 preferably including the engine, the ECU and the air conditioner.

In a further preferred embodiment, the data correcting unit 120 collects the mileage game data (S130).

Preferably, the data processing unit 130 suitably computes the mileage game score from the mileage game data according to the mileage game program 150 previously installed (S140), and suitably calculates the total score of the mileage game scores reflected by the generated mileage game score (S150). Preferably, the mileage game score is generated by the equation below:

mileage game score=[10+{(instant mileage/authorized gas mileage)*5}+[4-(RPM/1000)]+{(50 -acceleration opening rate (%))/10}-{|speed-70|/20}-air-conditioner adjusting level]

Next, in a further preferred embodiment, the total score of the calculated mileage game scores is suitably displayed on the display screen 140 (S160).

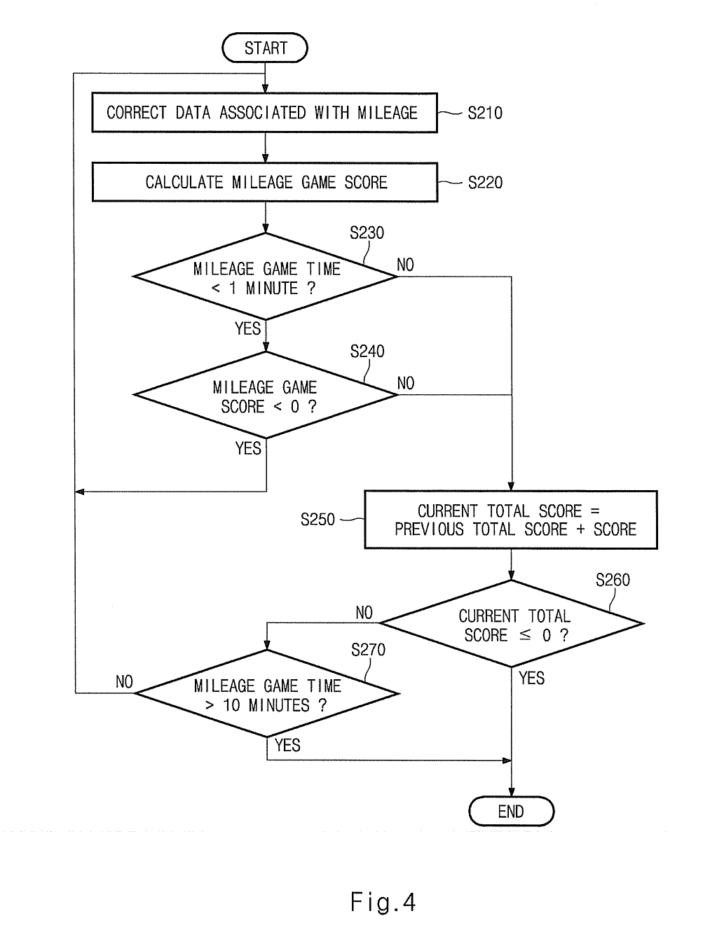

FIG. 4 is a flowchart illustrating operation of the mileage game system of the running vehicle according to another preferred embodiment of the present invention.

Referring to FIG. 4 for example, the mileage game method of the running vehicle according to an exemplary embodiment of the present invention is a game method in which a mileage game time is more than 1 minute and less than 10 minutes, and the mileage game time may preferably be varied.

Preferably, the mileage game method of the running vehicle according to an embodiment of the present invention collects data associated with gas mileage (i.e., mileage game data) which is suitably generated by the mileage game data generating unit 300 including, for example, the engine, the ECU and the air conditioner, by using the above-described CAN (S210), and then suitably computes the mileage game score (S220). As described herein, the mileage game data preferably includes an instant gas mileage, a vehicle speed, RPM, APS (accelerator pedal value signal), and an air conditioner adjusting level. According to preferred embodiments, the mileage game score is generated by the equation below:

[10+{(instant mileage/authorized gas mileage)*5}+[4-(RPM/1000)]+{(50 - acceleration opening rate (%))/10}-{|speed-70|/20}-air-conditioner adjusting level]

In further preferred embodiments, a mileage game proceeding time is counted, and it is suitably judged whether the time is less than a is predetermined lower limit, for example, 1 minute (S230). If the mileage game proceeding time is less than 1 minute, it is suitably judged whether the mileage game score is less than 0 (S240). Further, if the mileage game score is less than 0, the data associated with the gas mileage is again collected from the mileage data generating unit by using the CAN.

In further preferred embodiments, if the mileage game time is above 1 minute and the mileage game score is larger than 0, the mileage game score is suitably added by the calculated score, and the total score is set to the current total of the mileage game scores (S250).

Preferably, according to further embodiments, it is judged whether the current total score is less than 0 (S260). Preferably, if the total score is not less than 0, it is judged whether the mileage game proceeding time is more than the upper limit time, for example, 10 minutes (S270). Preferably, if the mileage game time has gone by 10 minutes, it proceeds to the step S210, and the process of collecting the mileage game data is suitably repeated.

In further preferred embodiments, if the current total score is less than 0 or the mileage game time is more than 10 minutes, the game is completed.

Although preferred embodiments of the present invention have been described for illustrative purposes, those skilled in the art will appreciate that various modifications, additions and substitutions are possible, without departing from the scope and spirit of the invention as disclosed in the accompanying claims.

What is claimed is:

1. A mileage game system for a running vehicle, comprising:
an operation unit enabling a driver to select a mileage game, and generating mileage game data having an influence on a gas efficiency;
a data collecting unit collecting the mileage game data by using a CAN communication;
a data processing unit computing a mileage game score from the mileage game data according to a mileage game program previously installed, and calculating the total score of the mileage game scores reflected by the generated mileage game score; and
a display screen displaying the total score of the calculated mileage game scores.

2. The mileage game system of claim 1, wherein the mileage game data includes an instant gas mileage, a vehicle speed, RPM, APS (accelerator pedal value signal), and an air conditioner adjusting level.

3. The mileage game system of claim 2, wherein the mileage game score is calculated by the mileage game data according to the following equation:
mileage game score=[10+{(instant mileage/authorized gas mileage)*5}+[4-(RPM/1000)]+{(50 -acceleration opening rate (%))/10}-{|speed-70|/20}-air-conditioner adjusting level]

4. The mileage game system of claim 2, wherein the mileage game data is generated by at least one of mileage game data generating units including an engine, an ECU and an air conditioner.

5. The mileage game system of claim 4, wherein the mileage game data generated by the engine and the ECU is transmitted via a high-speed chassis CAN, and the mileage game data generated by the air conditioner is transmitted through a low-speed body CAN or a multimedia CAN.

6. The mileage game system of claim 5, wherein the mileage game data generating unit respectively transmits a corresponding mileage game data to a CAN gateway in the one's CAN, and the CAN gateway transmits the corresponding mileage game data to the data collecting unit.

7. A mileage game method for a running vehicle, comprising the steps of:
A) collecting mileage game data by a data correcting unit;
B) computing a mileage game score from the collected mileage game data according to a mileage game program previously installed;
C) counting a mileage game proceeding time, and judging whether the time is less than a predetermined lower limit;
D) if the mileage game proceeding time is less than the predetermined lower limit, judging whether the mileage game score is less than 0;
E) if the mileage game time is more than the predetermined lower limit or the mileage game score is larger than 0, adding the calculated mileage game score to the previous total score so that the total score is set to the current total of the mileage game score;
F) judging whether the current total score is less than 0;
G) if the total score is not less than 0, judging whether the mileage game proceeding time has gone by a predetermined upper limit time, by counting the mileage game proceeding time; and
H) if the current total score is less than 0 or if the mileage game time has gone by the predetermined upper limit time, completing the game.

8. The mileage game method of claim 7, wherein if the mileage game score calculated at the step D is less than 0, the mileage game data is again collected via a CAN communication.

9. The mileage game method of claim 7, wherein the predetermined lower limit time is set to 1 minute, and the predetermined upper limit time is set to 10 minutes.

10. The mileage game method of claim 7, wherein
the mileage game data of the step A includes an instant gas mileage, a vehicle speed, RPM, APS (accelerator pedal value signal), and an air conditioner adjusting level.

11. The mileage game method of claim 10, wherein the mileage game score of the step B is calculated by the mileage game data according to the following equation:
mileage game score=[10+{(instant mileage/authorized gas mileage)*5}+[4-(RPM/1000)]+{(50 -acceleration opening rate (%))/10}-{|speed-70|/20}-air-conditioner adjusting level]

12. A mileage game system for a vehicle, comprising:
an operation unit;
a data collecting unit;
a data processing unit; and
to a display screen.

13. The mileage game system for a vehicle of claim 12, wherein the operation unit enables a driver to select a mileage game, and generates mileage game data having an influence on a gas efficiency.

14. The mileage game system for a vehicle of claim 12, wherein the data collecting unit collects the mileage game data by using a CAN communication.

15. The mileage game system for a vehicle of claim 12, wherein the data processing unit computes a mileage game score from the mileage game data according to a mileage game program previously installed, and calculates the total score of the mileage game scores reflected by the generated mileage game score.

16. The mileage game system for a vehicle of claim 12, wherein the display screen displays the total score of the calculated mileage game scores.
